(19) United States
(12) Patent Application Publication
(10) Pub. No.: US 2011/0064538 A1
(43) Pub. Date: Mar. 17, 2011

(54) CLAMPING BOLT

(76) Inventors: Max Oertle, Mauren (CH); Michael Maag, Sankt Gallen (CH); Rony Schnitzer, Ruggell (CH); Robert Galehr, Mauren (CH)

(21) Appl. No.: 12/950,245

(22) Filed: Nov. 19, 2010

Related U.S. Application Data
(63) Continuation of application No. PCT/EP2009/003124, filed on Apr. 30, 2009.

(30) Foreign Application Priority Data
May 20, 2008 (DE) 10 2008 024 405.8

(51) Int. Cl. F16B 19/02; F16B 43/00; B23P 11/00

(52) U.S. Cl. 411/360; 411/371.2; 29/505

(57) ABSTRACT

Clamping bolt for a securing device of an adjustable steering column, characterized in that at least one cam or at least one cam following contour is formed as one piece on the clamping bolt.

### CROSS REFERENCE

This application is a continuation application of International application No. PCT/EP2009/003124, filed Apr. 30, 2009, the entire disclosure of which is incorporated herein by reference.

### BACKGROUND OF THE INVENTION

a) Field of the Invention

The present invention relates to a clamp bolt for a securement device of an adjustable steering column. The invention, furthermore, also relates to a securement device for an adjustable steering column or an adjustable steering column with such a clamp bolt. Moreover, the invention relates to a method for the production of such a clamp bolt.

b) Description of Related Prior Art

Utilizing clamp bolts in securement devices for adjustable steering columns is known within prior art. The adjustable steering column herein comprises a setting part (=jacket unit or jacket tube) which rotatably supports the steering spindle, and a holding part (=mounting part), which is directly or indirectly connected to the motor vehicle body.

EP 1 500 570 A2 discloses an adjustable steering column in which the jacket tube is held between two side jaws of a mounting or carrier part. A securement device is provided which can be adjusted on demand between a detached setting in which the jacket tube is adjustable relative to the mounting part, and a fixed setting, in which the jacket tube is fixed relative to the mounting part. The securement device comprises a clamp bolt which penetrates the two shanks and the jacket tube transversely to the axis of the steering spindle. At one end the clamp bolt bears a nut and at the other end a clamp member. The clamp member is comprised of a cam disk whose cams cooperate with oblique faces (=cam follower) of the securement part, wherein the cam disk and the securement part are penetrated by the clamp bolt. Upon actuation of the actuation lever the cam is turned with respect to the oblique faces of the securement part, meaning the cam follower, wherein the cam changes its position along the cam follower contour and the distance between cam and cam follower changes relative to one another. Through the adjustment of the actuation lever into the fixed setting the clamp bolt is correspondingly placed under tensile stress with the aid of the clamp member and the nut, such that toothing elements are brought into engagement for fixing the steering column. If the actuation lever is moved into the detached setting, the toothing elements are correspondingly brought out of engagement and the jacket tube is adjustable with respect to the mounting part.

Since the cam cooperates with the cam follower in order to introduce the corresponding tensile stress into the clamp bolt, cam and cam follower contour have contours matched to one another. Metaphorically speaking, what is involved here are two mountain ranges cooperating with one another or meshing with one another and matched to one another in terms of their surface shape or contour. Determining which of these “mountain ranges” is the cam and which of these “mountain ranges” is the cam follower contour is herein a question of linguistic convention. The “mountain range” with the more pronouncedly projecting elevations is conventionally denoted as the cam and the “mountain range” with the more uniformly extending surface form or contour is denoted as cam follower contour. However, this must not be mandatorily so. In this respect, the cam follower contour can also be denoted as cam and, correspondingly, the cam as cam follower contour.

Alternatively to a form-fit engagement between toothing elements, solutions are known in prior art in which the side jaws of the mounting part are brought into frictional connection with side faces on the jacket tube in order to fix the jacket tube, wherein the remaining elements of the securement device are substantially the same. An example of such is EP 1180466 A2.

In the securement devices for adjustable steering columns known so far, clamp bolts are utilized which cooperate with separately fabricated cam disks. The cams disposed on the cam disks are guided by means of the clamp bolt over a cam follower contour of a, again separately fabricated, cam follower disk. The cam disk with the cams disposed thereon as well as also the cam follower disk with the cam follower contour disposed thereon are produced in prior art as separate structural parts, frequently using a sintering method, and are subsequently secured in position on the clamp bolt or on the securement device. Due to the large number of individual parts, mounting such systems entails high expenditures.

FIG. 1 depicts an adjustable steering column 3 according to prior art. This column comprises a steering spindle 22 rotatably supported in the setting unit implemented here as a jacket unit 23. The jacket unit 23 is retained via the securement device 2 on a bracket unit 24 which can be secured in position on the chassis of a motor vehicle by means of a securement joint bar 25 in a manner known per se. The steering spindle 22 depicted in FIG. 1, such as is known in prior art, can be height-adjusted in its longitudinal directions 36 as well as also in the directions 37 by sliding or swivelling the jacket unit 23 correspondingly relative to the bracket unit 24. This is known per se and does not need to be explained further.

In order to lock the jacket unit 23 and the steering spindle 22 in the once set position, the securement device 2 is provided in the depicted example. This device comprises a clamp bolt 1′, a lever 18, a cam disk 6′, a cam follower disk 10, a securement part 19 with the toothings disposed thereon and a washer 27 as well as a nut 28. The structural parts of the securement device 2 are illustrated in the depicted example in a representation taken apart in exploded view. In the assembled state the clamp bolt 1 can be rotated about its longitudinal axis 7 by swivelling the lever 18 about the clamp bolt axis 7, wherein the cam disk 6′ is simultaneously rotated, which disk is torsion-tight connected with the clamp bolt 1 through suitable means. The cam follower disk 10 with the cam follower contour 5 is secured torsion-tight in position on the securement part 19 which, in turn, via a toothing 20 engages torsion-tight into a corresponding countertoothing of the side jaws 21 of the bracket unit 24. As is known per se, through this disposition is attained that during the swivelling of the lever 18 the cams 4′ of cam disk 6′ slide along on the corresponding cam follower contour 5 of cam follower disk 10. Through the ramp-like sections provided on the cam follower contour 5 occurs an enlargement of the distance between these two structural parts by turning the cam disk 6′ relative to the cam follower disk 10, which, in turn, leads to a tightening by means of clamp bolt 1′ thereby that the clamp bolt 1′ presses the two opposing side jaws 21 of the bracket unit 24 together, whereby the jacket unit 23 is arrested in the once set position. To detach the securement device 2, the lever 18 is swivelled into the opposite direction and therewith the clamp bolt 1′ and the cam disk 6′ are rotated into the opposite direction.

In prior art the clamp bolt 1′, the cam disk 6′ and the cam follower disk 10 are implemented as separate structural parts, which most often are connected with one another or with other structural parts by form-fit closure. FIG. 2 depicts a top view onto a cam disk 6′ known in prior art with four cams 4′ disposed thereon. In the center is located a hole 29 through which the camp bolt 1′ is pushed. The means for the torsion-tight connection of the cam disk 6′ with the clamp bolt 1′, as a rule, are located on the backside of the cam disk 6′ which cannot be seen in FIG. 2. In prior art the cams 4′ are implemented, as a rule, such that their cross sectional area increases with increasing distance in the radial direction 9, starting from the central hole 29, as is also evident in FIG. 2.

### SUMMARY OF THE INVENTION

The invention addresses the problem of reducing the number of parts of a securement device and of proposing an improved solution for a securement device compared to prior art.

This problem is resolved by forming at least one cam or at least one cam follower contour in one piece or unitarily on the clamp bolt.

The invention consequently provides that the clamp bolt and at least one cam are formed as a unitary structural part or that the clamp bolt and at least one cam follower contour are correspondingly formed as a unitary structural part. By unitary is understood in this context that the clamp bolt and the at least one cam or the clamp bolt and the at least one cam follower contour are jointly produced as one piece or as an integral structural part. Not unitary in this sense is if the clamp bolt and the cam or the cam follower contour are initially produced as separate structural parts and subsequently are joined or connected with one another using additional means, such as for example are welded, adhered, riveted, bolted and the like with one another. Thus, from the outset there are no joint faces between clamp bolt and cam or between clamp bolt and cam follower contour. Through the clamp bolt according to the invention, assembling the securement device is simplified through the unitary realization and therewith becomes more cost-effective. Thus, in corresponding sections through these structural parts no joint faces are evident.

At least one of the cams is preferably disposed on a disk, the cam disk, which is also realized unitarily with the clamp bolt. Especially preferred is disposing all cams on this disk. Alternatively, the cam follower contour can be disposed on a disk, the cam follower disk, which in this case is preferably realized unitarily with the clamp bolt. In this case it is especially preferred for the entire cam follower contour to be disposed on this disk. The cam disk or cam follower disk are denoted as disks for the reason that their axial extent, which is delimited by their front faces, is preferably markedly shorter than their radial extent, which is delimited by their circumferential face. The cam disk, or alternatively the cam follower disk, is preferably so disposed that the surface normals of their front face are oriented approximately parallel to the clamp bolt axis which extends longitudinally along the clamp bolt. In a direction parallel to the clamp bolt axis, the cam contour of the cams or the cam follower contour is preferably elevated over the cam disk (or protruding or projecting) over the cam disk toward the cam disk or cam follower disk. Since in terms of fabrication technology a greater advantage compared to the integral realization of the clamp bolt with the cam follower disk results, it is especially preferred to realize the cam disk with the cams unitarily with the clamp bolt. It is in principle conceivable to employ only one cam. However, for reasons alone of symmetric force introduction into the clamp bolt, it is, as a rule, favorable if several cams, for example pairwise radially opposingly or distributed uniformly over the circumference of the clamp bolt are formed onto the clamp bolt. Accordingly, it is also preferably provided that the clamp bolt extends longitudinally along a clamp bolt axis and the cam(s), referred to the clamp bolt axis, project in the radial direction beyond the clamp bolt. Stated differently, the cams are disposed such that they are elevated in the direction of the clamp bolt axis, wherein the elevated contour extends in the radial direction on the cam disk.

In a preferred embodiment, the clamp bolt projects beyond the cams and, if provided, the cam disk bilaterally in the direction of the clamp bolt axis.

It is herein preferably provided that the cam(s) preferably on the clamp bolt, preferably cooperate directly with the cam follower contour, preferably on the steering column. In particular when turning the clamp bolt, preferably with respect to the cam follower contours, the cam or the cams slide out on the cam follower contour. It is herein irrelevant whether or not a setting lever actuates directly the clamp bolt with the cam or the cams disposed thereon in the rotational direction or the cam follower contour. The same applies in the converse case when the cam follower contour is realized unitarily with the clamp bolt.

In the especially preferred embodiment, three cams are disposed on the cam disk, wherein the cams are realized with a cross sectional area that is preferably constant or decreasing with increasing distance from the clamp bolt in the radial direction with respect to the clamp bolt axis. The clamp bolt according to the invention is herein preferably produced by plastic deformation, especially preferred by flow forming (impact extrusion).

Several plastic deformation methods are known the in prior art. They have in common that they involve a plastic change of the shape of a solid body while maintaining its mass and material composition. For the production of a clamp bolt according to the invention, for example the so-called flow forming (impact extrusion) method can be applied. According to DIN 8583 this flow forming method involves a forming method under compressive conditions or a bulk deformation, which can prepare hollow as well as also solid bodies using a single-stage or multistage manufacturing process. In this method the material is made to flow under the action of high pressure. A male die presses herein the workpiece blank through a forming female die. The plastic deformation most often takes place at ambient temperature, wherein high dimensional accuracy as well as high surface quality can be attained. It is conceivable and feasible to heat the blank for the deformation.

An adjustable steering column with a securement device including a clamp bolt according to the invention preferably comprises a setting unit rotatably bearing supporting the steering spindle, which unit is in particular realized in the form of a jacket unit, encompassing the steering spindle. A bracket unit can be secured in position on the chassis of the motor vehicle, with respect to which the setting unit is adjustable in the opened position of the securement device preferably in the height and/or longitudinal direction of the steering spindle. The setting unit in the closed position of the securement device is fixed in its position on the bracket unit.

The securement device can provide toothings or the like for the form-fit securement in position or fixing of the setting unit on the bracket unit in the closed state of the securement unit. Alternatively, it is also feasible for the setting unit to be held or secured in position under friction closure in the closed state of the securement unit, for example, via disk packs. Advantageous embodiments provide that the bracket unit comprises two side jaws between which the setting unit is disposed. The side jaws are preferably pressed onto the setting unit in the closed position of the securement device. The clamp bolt preferably extends transversely to the longitudinal axis of the steering spindle and penetrates through openings in the side jaws and possibly also in the setting unit.

### BRIEF DESCRIPTION OF THE DRAWINGS

Further details and characteristics of the present invention can be found in the description of the Figures.

In the drawings:

FIGS. 1 and 2 show steering column of the prior art,

FIGS. 3 and 4 shows a first embodiment of a clamp bolt according to the invention,

FIGS. 5 to 7 shows four different positions of a cam on a cam follower contour,

FIG. 8 is a top view onto the cam disk depicted in FIGS. 5 to 7 with cams,

FIGS. 9 and 10 is a depiction of the cam follower contour, assigned to the cams of the cam disk according to FIG. 8, on the cam follower disk,

FIGS. 11 and 12 show sections along the section lines AA and BB according to FIG. 8,

FIG. 13 is a top view onto a further embodiment of a clamp bolt according to the invention,

FIG. 14 shows a further embodiment of a clamp bolt according to the invention in top view,

FIG. 15 shows the cam follower contour assigned to the embodiment example according to FIG. 13,

FIGS. 16 and 17 shows sections along the section lines CC and DD of FIG. 13,

FIG. 18 shows an embodiment of the steering column according the invention in pulled apart depiction analogous to the depiction of prior art according to FIG. 1, and

FIG. 19 a schematic view of an alternative embodiment of a cam follower disk with cam follower contour.

### DETAILED DESCRIPTION OF THE PREFERRED EMBODIMENTS

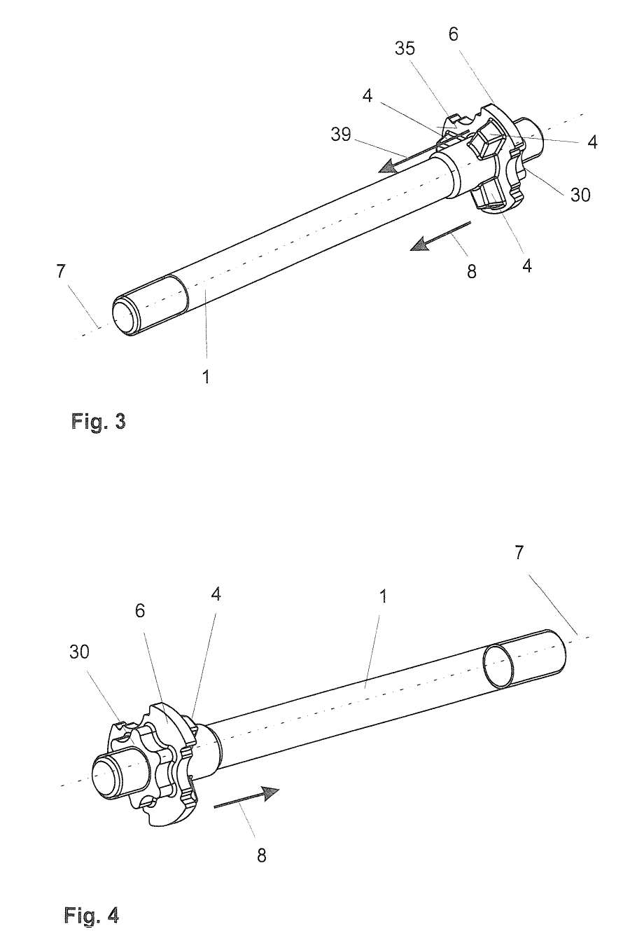

FIGS. 3 and 4 depict a first embodiment of the clamp bolt 1 according to the invention, in which the cams 4 and the cam disk 6 are unitarily formed on the clamp bolt 1. FIG. 3 depicts a perspective view in which the cams 4 can be seen especially well. FIG. 4 depicts a perspective view from the opposite direction.

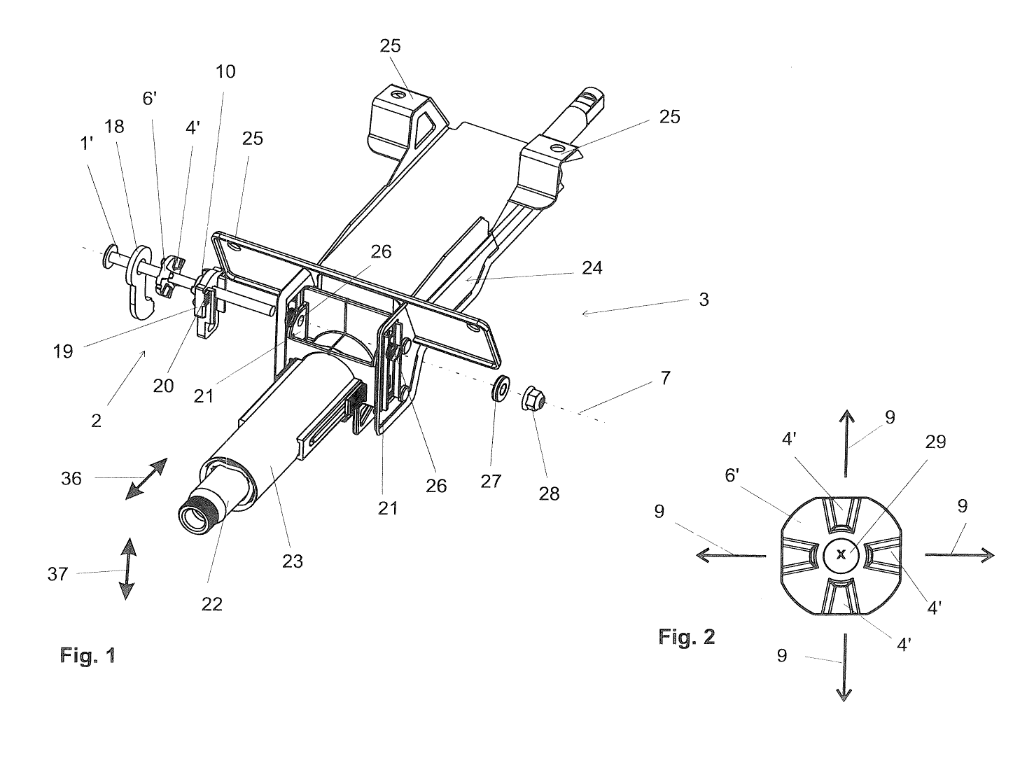

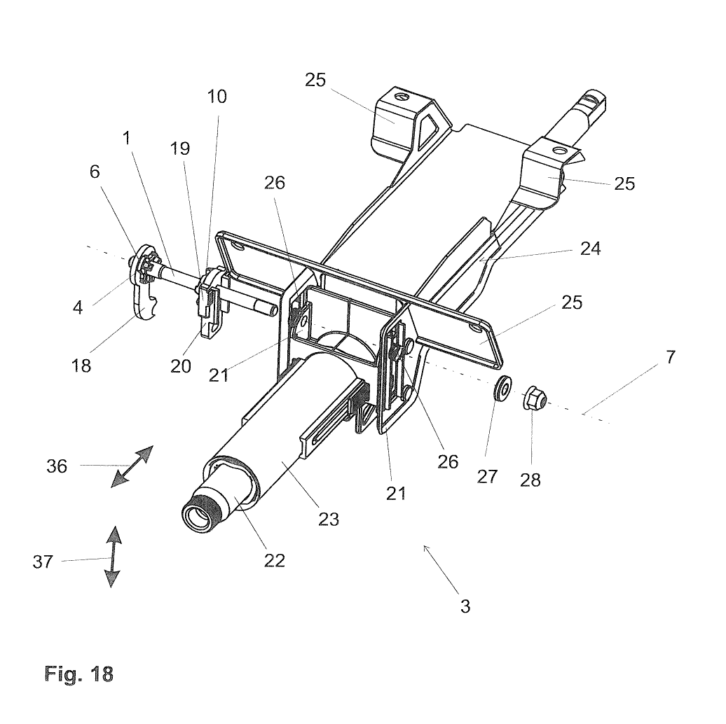

In the depicted embodiment, the clamp bolt axis 7 extends parallel to the surface normal 39 of the upper front face or the surface 35 of the cam disk 6. The three cams 4 project beyond the cam disk 6 in the direction 8, which extends correspondingly parallel to the surface normal 39 parallel to the clamp bolt axis 7. The cams 4, moreover, also project in a particular radial direction 9, referred to the clamp bolt axis 7, beyond the (cylindrical region of the) clamp bolt(s) 1. Stated differently: the cams 4 are elevated in the direction of the cam bolt axis on one of the front faces of the cam disk 6, on the cam disk 6, wherein the elevated contour extends in the radial direction on the cam disk 6. With increasing distance from clamp bolt 1, the cross sectional area of cams 4 has constant or decreasing values. This will be shown and explained later in further detail. In FIG. 4 is illustrated an embodiment of the clamp bolt according to the invention, in which on the front face of cam disk 6 opposing the cam 4 a formed part 30 is formed on, for example for implementing a form-fit connection with a lever 18 of the securement device 2 explained in the introduction. An embodiment according to the invention of a securement device 2 or an adjustable steering column 3 results if the clamp bolt 1′ and the cam disk 6′ of prior art in the embodiment example according to FIG. 1 is replaced by the clamp bolt 1 according to the invention with unitarily formed on cams 4 and cam disk 6, as is shown in FIG. 18. The other features, such as have already been described for FIG. 1, are here implemented in the same manner. It is understood that this is only an example. In the adjustable steering columns 3 implemented according to the invention a height and/or a depth adjustment can be realized. The clamping mechanism actuated by means of the clamp bolt 1 according to the invention can comprise a toothing, such as is depicted in FIG. 1 or in EP 1 500 570 A2, provided for the form-fit closure. Clamp bolts according to the invention can, however without limiting the application thereto, be employed in all steering columns which are implemented according to prior art with separately produced clamp bolts and cams and cam followers. Thus, the employment is feasible in steering columns in which the fixing of the set position takes place via a tightening under frictional closure. The same applies to all embodiment examples according to the invention yet to be subsequently described.

In the embodiment according to the invention illustrated in FIGS. 3 and 4, the clamp bolt 1 projects beyond the cams 4 as well as also the cam disk 6 as well as also the formed part 30, bilaterally in the direction of the clamp bolt axis 7.

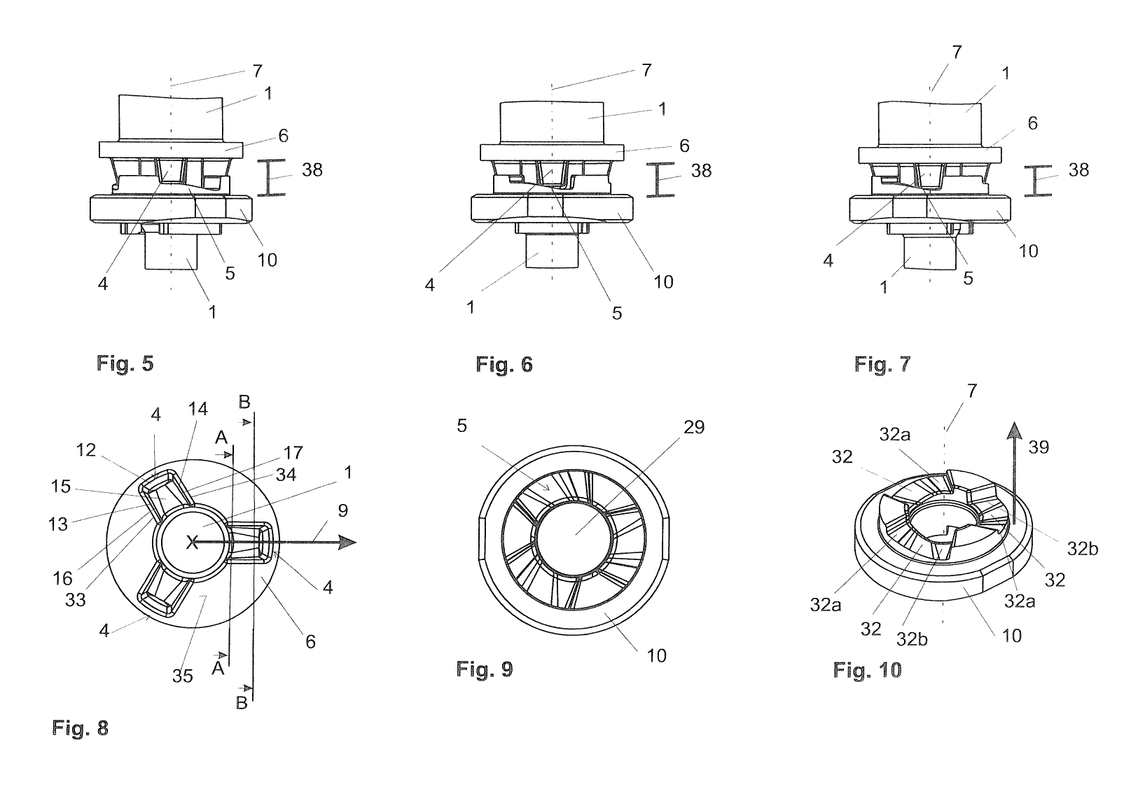

FIGS. 5 to 8, 11 and 12 depict several representations of a second embodiment according to the invention, in which the cam disk 6 and the cams 4 disposed thereon are also unitarily formed on the clamp bolt 1. The cam follower disk 10, described in FIGS. 9 and 10 provided as a counterpiece, includes the central hole 29, through which the clamp bolt 1 can be guided. The front side of the cam follower disk 10 facing away from the cam follower contour 5 is connected torsion-tight in a manner known per se with a corresponding structural part of the securement device 2, such that by rotation of the clamp bolt 1 about the clamp bolt axis 7 the cams 4 slide along on the cam follower contour 5. In the depicted embodiment the cam follower contour 5 comprises, corresponding to the number of cams 4, three internally correlating cam follower contour sections. Each of these three sections is formed by a ramp-like region 31 rising in the direction of the clamp bolt axis 7 with two adjacent and opposing plateau regions 32a and 32b. The rising region 31 is preferably provided in a first region 31a and a further region 31b directly adjoining thereto, the inclination of which is less than that of the first region 31a. Further subdivisions can preferably be implemented in the rising region. Such an implementation of the cam follower contour is schematically illustrated in FIG. 19. FIGS. 5 to 7 depict several positions in which the cams 4 can be in contact on the particular regions of the cam follower contour 5. FIG. 5 shows the operating position in which the cams 4 are resting on the plateau regions 32a corresponding to the closed position. In this position the distance 38 between cam disk 6 and cam follower disk 10 is maximal. The securement device is in the clamped end position or the closed position in which the jacket unit 23 is arrested in its position in the longitudinal direction 36 and/or 37, the height. FIG. 6 depicts an intermediate position in which the cams 4 slide along on the rising region 31 of cam follower contour 5. FIG. 7 depicts the second end position in which the cams are in contact on the plateau regions 32b. This corresponds to the opened position of the securement device 2, in which the steering spindle 22 or the jacket unit 23 can be adjusted in its position relative to the bracket unit 24. For the arresting, the clamp bolt 1 is rotated by actuation of the lever 18 into a direction in which the cams 4 are again rotated into the closed position depicted in FIG. 5. FIG. 9 depicts a top view onto the cam follower contour 5. FIG. 10 depicts a perspective view. It is understood that the out-forming or molding of the cam follower contour 5 depicted here is only an example. As a rule, it is adapted to the shape of the cams 4.

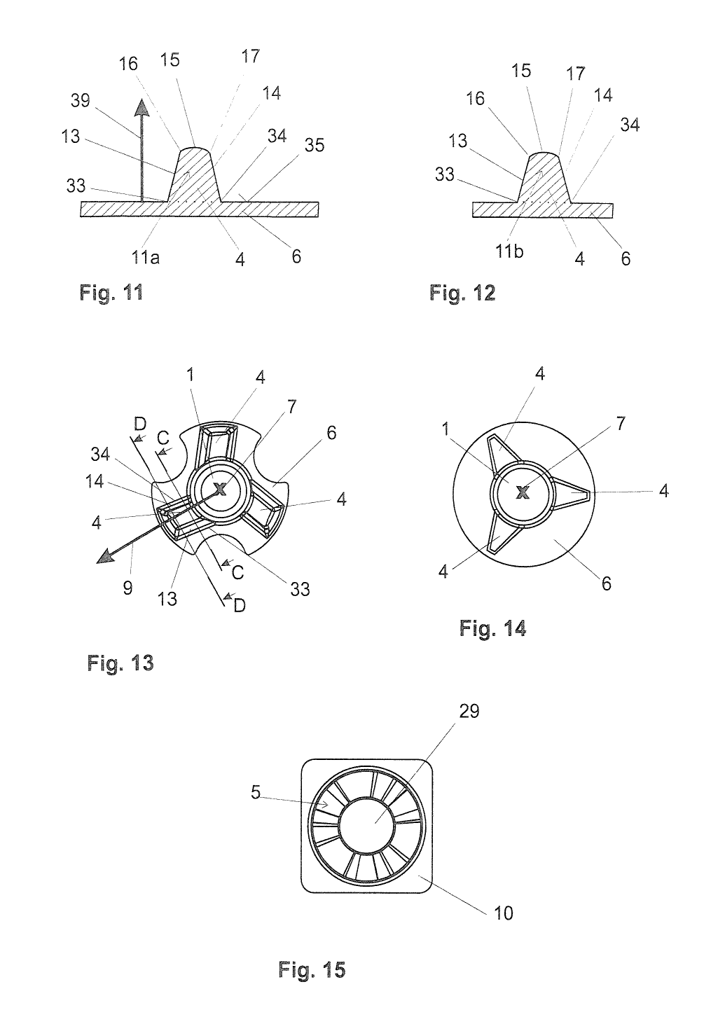

FIG. 8 depicts a top view onto the cams 4, disposed on the cam disk 6, of this embodiment example from the direction of the clamp bolt axis 7. All three cams 4 of this embodiment example have the same form. Opposing the clamp bolt 1 is located the front face 12 of the particular cam 4. Between the clamp bolt 1 and the front face 12 extend in each instance the two opposite side faces 13, 14 of the cam. On the side opposite the cam disk 6 the surface of each cam is formed by the top face 15. Between the top face 15 and the side face 13 extends at least one first upper edge 16. Between the top face 15 and the opposing side face 14 extends at least one second upper edge 17. The two listed upper edges 16 and 17 of this embodiment example extend parallel to one another. Between the side face 13 and the surface 35 of the cam disk 6 extends the first lower edge 33. Between the second side face 14 and the surface 35 of the cam disk 6 extends the second lower edge 34. These two lower edges also extend parallel to one another. In the radial direction 9 the side faces 13 and 14 extend at constant distance to one another. The top face 15 of each cam 4 is in each case implemented minimally arcuate. The distance between top face 15 and surface 35 of the cam disk 6 decreases minimally in the radial direction 9 with increasing distance from the clamp bolt axis 7 until the front face 12 is reached. Through this physical form of the cams is attained that each cam has a cross sectional area decreasing with increasing distance from the clamp bolt 1. To illustrate this, the sections AA and BB are shown in FIGS. 11 and 12 extending parallel to the bolt axis 7. The straight line extending, starting from the clamp bolt axis 7, radially in direction 9 forms a surface normal on both section planes. FIG. 11 depicts the section along the section line AA, FIG. 12 depicts the section along sections BB. This allows comparing the cross sectional areas 11a and 11b with one another. For better visualization these are shown in FIGS. 11 and 12 by a dashed line separate from the cross sectional area of the cam disk 6. It is understood that this type of depiction does not mean that the cams 4 and the cam disk 6 are separate structural parts. As explained above, these are implemented unitarily. Among the cross sectional area 11a or 11b is counted that portion which is located above the surface 35 of the cam disk 6. The comparison of FIGS. 11 and 12 shows that the cross sectional area of the cams of this embodiment example decreases minimally with increasing radial distance from the clamp bolt axis 7. Alternatively, it could also be constant. The value of the cross sectional area is, according to the invention, either constant or decreases with increasing distance from the clamp bolt axis measured in the radial direction 9. The change of the cross section is herein monotonic. That means that the decrease of the cross sectional area or the constancy of the cross sectional area, however especially the non-increase of the cross sectional area with increasing distance from the clamp bolt axis 7, preferably in each instance, applies to the entire region between clamp bolt and front face 12.

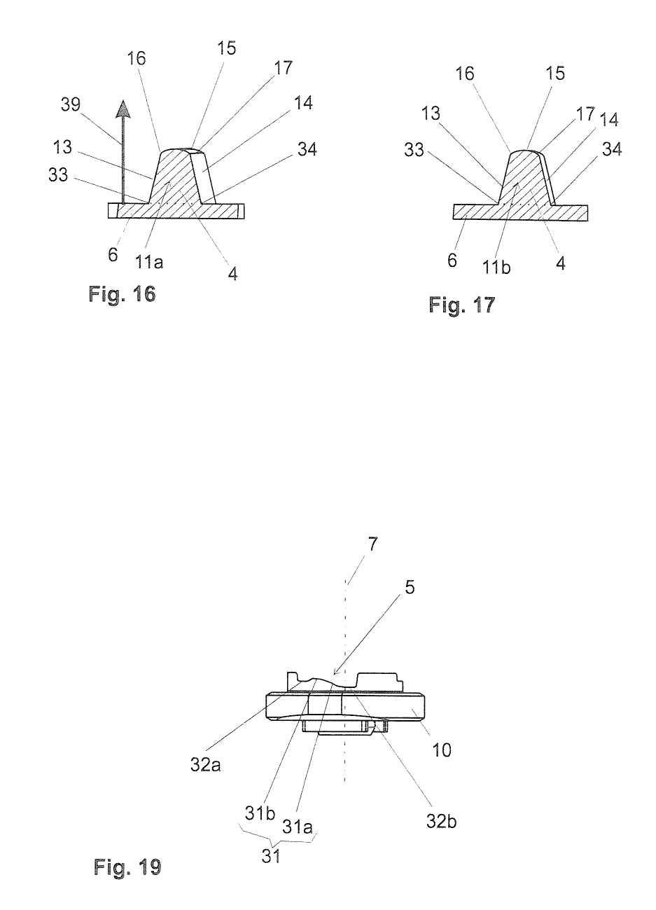

FIG. 14 depicts a top view onto a cam disk 6 with clamp bolt 1 and cams 4, also unitarily formed on. The cams 4 are herein so implemented that their cross sectional area with increasing distance in the radial direction from the clamp bolt axis 7 decreases relatively strongly, by more than 20 percent, and therewith also decreases more than in the embodiment example according to FIGS. 5 to 12. FIG. 13 depicts a further embodiment example according to the invention. Here the upper edges 16 and 17 of cams 4 extend parallel to one another, as do also the lower edges 33 and 34. Said edges, however, do not extend parallel to the radial direction 9, as was the case in the embodiment example according to FIGS. 5 to 12, but rather form an acute angle therewith. In this embodiment example there is also ensured that the cross sectional area, determined normal to a radial direction 9 with respect to the clamp bolt axis 12, remains constant or decreases minimally with increasing distance in the radial direction 9 from the clamp bolt axis 7. FIG. 16 depicts a section along section line CC, FIG. 17 depicts a corresponding section along the section line DD. FIG. 15 depicts the cam follower contour 5 correspondingly formed out for the embodiment example according to FIG. 13.

In the embodiments according to the invention depicted here, three cams each are unitarily connected with the clamp bolt 1. It is understood that this is only an example. One, two or more than three cams 4 can also be involved.

Within the scope of the invention is also not mandatorily provided that the cams 4 and the cam disk 6 are connected unitarily with the clamp bolt. It is also conceivable, as already explained above, to connect the cam follower contour 5 optionally together with the cam follower disk 10 unitarily with the clamp bolt. In this case, as a counterpiece the cam disk 6′ is connected with the cams 4′ torsion-tight with a suitable other structural part of the securement device 2. In these embodiment variants it is then preferably provided that the cam follower contour 5 projects in direction 8 parallel to the clamp bolt axis 7 beyond the cam follower disk 10. In this case, such a disk comprises, for example analogously to FIGS. 9, 11 and 16, plateau regions 32 and 32′ spaced differently far in the direction 8 parallel to the clamp bolt axis 7 from the cam follower disk 10 or in between regions 31 rising or falling in the direction 8. The cam follower contour 5, it is understood, preferably also projects in the radial direction 9 beyond the (cylindrical portion of the) clamp bolt(s) 1.

### LEGEND TO THE REFERENCE NUMBERS

1, 1′ Clamp bolt
2 Securement device
3 Steering column
4, 4′ Cams
5 Cam follower contour
6, 6′ Cam disk
7 Clamp bolt axis
8 Direction
9 Radial direction
10 Cam follower disk
11a, 11b Cross sectional area
12 Front face
13 Side face
14 Side face
15 Top face
16 First upper edge
17 Second upper edge
18 Lever
19 Securement part
20 Toothing
21 Side jaw
22 Steering spindle
23 Jacket unit
24 Bracket unit
25 Securement joint bar
26 Hole
27 Washer
28 Nut
29 Hole
30 Formed part
31, 31a
31b Rising regions
32a, 32b Plateau region
33 First lower edge
34 Second lower edge
35 Surface
36 Longitudinal direction
37 Direction of height
38 Distance
39 Surface normal

1-15. (canceled)

16. Clamp bolt for a securement device of an adjustable steering column, wherein on the clamp bolt at least one cam is unitarily formed on, wherein cam has a constant or decreasing cross sectional area with increasing distance from the clamp bolt.

17. Clamp bolt as claimed in claim 16, wherein the cam or the cams are disposed on a cam disk, wherein the cam disk and the cam or the cams are unitarily formed on the clamp bolt.

18. Clamp bolt as claimed in claim 17, wherein the clamp bolt is longitudinally extended along a clamp bolt axis and the cam or the cams project in a direction parallel to the clamp bolt axis beyond the cam disk.

19. Clamp bolt as claimed in claim 16, wherein the clamp bolt is longitudinally extended along a clamp bolt axis and the cam or the cams, referred to the clamp bolt axis, project in the radial direction beyond the clamp bolt.

20. Clamp bolt as claimed in claim 16, wherein on the clamp bolt the cam or the cams are unitarily formed on by plastic deformation.

21. Clamp bolt as claimed in claim 20, wherein the plastic deformation is an impact extrusion.

22. Clamp bolt as claimed in claim 16, wherein on the clamp bolt the cam or the cams together with the cam disk are unitarily formed on through plastic deformation.

23. Clamp bolt as claimed in claim 22, wherein the plastic deformation is an impact extrusion.

24. Clamp bolt as claimed in claim 16, wherein each cam has a constant or decreasing cross sectional area with increasing distance from the clamp bolt.

25. Clamp bolt as claimed in claim 16, wherein the clamp bolt is longitudinally extended along a clamp bolt axis and at least one cam has a cross sectional area, determined normal to a direction radial with respect to the clamp bolt axis, which remains constant or decreases with increasing distance in the radial direction from the clamp bolt axis.

26. Clamp bolt as claimed in claim 16, wherein the clamp bolt is longitudinally extended along a clamp bolt axis and each cam has a cross sectional area determined normal to a radial direction with respect to the clamp bolt axis, which remains constant or decreases with increasing distance in the radial direction from the clamp bolt axis.

27. Clamp bolt as claimed in claim 16, wherein one of the cams has a front face opposite the clamp bolt and two side faces opposing one another and extending between the front face and the clamp bolt, wherein the distance or the distances between the side faces are constant or decrease with increasing distance from the clamp bolt.

28. Clamp bolt as claimed in claim 16, wherein each cam has a front face opposite the clamp bolt and two side faces opposing one another and extending between the front face and the clamp bolt, wherein the distance or the distances between the side faces remain constant or decrease with increasing distance from the clamp bolt.

29. Clamp bolt as claimed in claim 17, wherein one of the cams has a front face opposing the clamp bolt and two side faces opposite to one another and extending between the front face and the clamp bolt and a top face extending between the front face and the clamp bolt and opposing the cam disk, wherein between the top face and the one side face at least one first upper edge is disposed, and between the top face and the side face opposite the one side face at least one second upper edge is disposed, wherein the first and the second upper edge extend parallel to one another or taper toward one another with increasing distance from the clamp bolt.

30. Clamp bolt as claimed in claim 17, wherein each cam has a front face opposing the clamp bolt and two side faces opposite to one another and extending between the front face and the clamp bolt and a top face extending between the front face and the clamp bolt and opposing the cam disk, wherein between the top face and the one side face at least one first upper edge is disposed, and between the top face and the side face opposite the one side face at least one second upper edge is disposed, wherein the first and the second upper edge extend parallel to one another or taper toward one another with increasing distance from the clamp bolt.

31. Securement device for an adjustable steering column with a clamp bolt as claimed in claim 16.

32. Adjustable steering column with a securement device with a clamp bolt as claimed in claim 16.

33. Method for the production of a clamp bolt as claimed in claim 16, wherein on the clamp bolt the cam or the cams are unitarily formed on by plastic deformation.

34. Method as claimed in claim 33, wherein the plastic deformation is an impact extrusion.

35. Method for the production of a clamp bolt as claimed in claim 16, wherein on the clamp bolt the cam or the cams together with the cam disk are unitarily formed on by plastic deformation.

36. Method as claimed in claim 35, wherein the plastic deformation is a flow forming.
